(19) United States
(12) Patent Application Publication
(10) Pub. No.: US 2026/0017817 A1
(43) Pub. Date: Jan. 15, 2026

(54) Visual Anchor Based User Coordinate Space Recovery System

(71) Applicant: Magnopus, LLC, Los Angeles, CA (US)

(72) Inventors: Kevin Mullican, Los Angeles, CA (US); Vivek Reddy, Bengaluru (IN); Sujay Hosahalli Ganesh Reddy, Bengaluru (IN)

(73) Assignee: Magnopus, LLC, Los Angeles, CA (US)

(21) Appl. No.: 19/338,748

(22) Filed: Sep. 24, 2025

Related U.S. Application Data
(63) Continuation of application No. 17/954,600, filed on Sep. 28, 2022, now abandoned.
(60) Provisional application No. 63/250,152, filed on Sep. 29, 2021.
(60) Provisional application No. 63/250,126, filed on Sep. 29, 2021.
(60) Provisional application No. 63/250,145, filed on Sep. 29, 2021.
(60) Provisional application No. 63/250,159, filed on Sep. 29, 2021.

(51) Int. Cl. G06T 7/70; G01S 19/49; G06T 17/00; G06T 19/00; G06V 10/24; G06V 10/44; G06V 10/74

(52) U.S. Cl. CPC G06T 7/70; G01S 19/49; G06T 17/00; G06T 19/006; G06V 10/245; G06V 10/44; G06V 10/761; G06T 2207/30204

(57) ABSTRACT

The present disclosure relates to augmented reality, virtual reality, mixed reality, and extended reality systems, and more specifically, to systems and methods for a visual positioning system.

### CROSS-REFERENCE TO RELATED APPLICATIONS

Pursuant to 35 USC sections 119(e) and 120, this application is a continuation of and claims the benefit of priority from co-pending U.S. patent application Ser. No. 17/954,600 entitled “Visual Anchor Based User Coordinate Space Recovery System” filed on Sep. 28, 2022, which claims the benefit of priority from four (4) U.S. provisional patent applications, No. 63/250,152 entitled “Visual Anchor Based User Coordinate Space Recovery System” filed Sep. 29, 2021, No. 63/250,126 entitled “Point of Interest System and Method for AR, VR, MR, and XR Connected Spaces” filed Sep. 29, 2021, No. 63/250,145 entitled “Platform Agnostic Autoscaling Multiplayer Inter and Intra Server Communication Manager System and Method for AR, VR, Mixed Reality, and XR Connected Spaces” filed Sep. 29, 2021, and No. 63/250,159 entitled “Bi-directional Cross-Platform Library for Automated Reflection” filed Sep. 29, 2021, all of the entire disclosures of which are incorporated herein by reference.

### FIELD OF THE INVENTION

The present disclosure relates to augmented reality, virtual reality, mixed reality, and extended reality systems, and more specifically, to systems and methods for visual positioning.

### BACKGROUND OF THE INVENTION

Current systems exist that make use of technologies including augmented reality (“AR”), virtual reality (“VR”), and mixed reality (“MR”) which are collectively known as extended reality (“XR”), artificial intelligence (“AI”), and the fifth-generation technology standard (“5G”) for broadband cellular networks.

In this context, physical reality often refers to a physical place where a person has to be there to see it and everyone present sees essentially the same thing. MR or augmented reality AR is similar, but they differ from physical reality in that a person is in the physical place but that person can see digital content mixed with the physical objects. People present in MR or AR environments can see shared experiences, or the content can be unique to an individual and their interests.

In contrast, VR refers to an environment where a person is remote from the physical place but feels like they are in the physical space. The person can see digital content mixed with digital copies of physical objects. The person may also be able to see shared experiences with other people or see content unique to the individual. XR encompasses AR, VR, MR, and those things in between or combinations thereof.

Work in this area includes work on what has been termed the metaverse. While metaverse has multiple meanings, the term is often used more in relation to a fictional, imaginary, an/or virtual world, rather than to the physical world.

Prior work also relates to what has been termed a mirror world. The term mirror world often is used to mean a “digital twin” of the physical world so that a user can access everything in the physical world, such as when playing a 3D video game.

Prior work also includes work on what has been termed the AR Cloud. The AR Cloud concept is about a coordinate system and content delivery.

Initial work has begun on Web XR, which is a standard that will use web technologies to make immersive content available to VR, AR, and 2D devices through a web browser. It is desirable to have a system for creating a connected space that can be compatible with a Web XR standard.

In augmented reality, it remains a significant challenge to place multiple three-dimensional (“3D”) objects accurately within a large real-world site using only identifiable natural and manmade features. Moreover, it is difficult to precisely tie a digital model of a real place to its real-world location in a way that maintains multiple object-user and user-user relations and allows freedom of movement within a large space.

While a digital twin primarily refers to virtual replicas of physical, digital, or imaginary spaces, those digital spaces may feature interactions or augmentations that are not naturally visible in the real world. To achieve parity across the digital and real worlds, those augmentations need to be represented to users in reality, meaning the augmentations must be presented in both the digital and physical worlds.

Representing a single 3D object in the physical world has become commonplace. The standard augmented reality experience generates an animation or 3D object over a real piece of scenery for a single user or device pointed towards a region or QR code. This fundamental augmented reality experience can seem mystifying to users years after its conception. However, several difficulties are encountered at scale.

The primary constraints of the problem are accuracy and subtlety. A virtual object's location needs to be lined up exactly with real-world features at various times of day. Furthermore, a camera's position and orientation within a space need to be as realistic as possible to properly take advantage of the fidelity of an object's placement within the real and virtual worlds. This accuracy can be improved with scannable markers, but venue operations and visitors do not like barcodes, symbols, and images cluttering locations. Once an augmentation is sufficiently accurate, the challenge shifts to maintaining multiple user-user and object-user relationships and monitoring the health of numerous, diffuse anchors within a large area.

There is a need to be able to fill a massive real-world space as accurately as possible with users viewing digital art from different perspectives through the lens of an AR-capable device while taking into account these goals, limitations, and problems.

Prior approaches include the use of QR codes or discrete symbols to trigger augmented reality activations. When a user points their camera at a QR code or symbol pattern, they will either be redirected to an AR-compatible web application, or the content will become visible through whichever application (app) they are currently using.

While QR codes are easily visible and distinguishable, the discreteness of feature points leaves them susceptible to change. If an object is moved, or a shadow cast in the wrong direction, these feature points will have to be re-established to provide a useful anchor.

Microsoft and Google also have visual positioning solutions that are based on a camera feed finding an anchor rather than the use of QR codes. Their approaches utilize computer vision algorithms to find anchors based on feature points that the camera can see. Once the location is established, the related piece of content is simply delivered to the user's device and superimposed over the user's camera feed.

Acquired by Niantic, 6Dai has a similar approach, but instead of using particular feature points, a user scans the entirety of the area they are in with their device's camera, and a server stores that mesh and compares it to others to find where the user is and which activation is relevant to the user. The content is delivered to the user, but the user's camera is not brought into the virtual world.

While the QR code systems are simple and accurate, adding discrete QR codes, barcodes, and/or markers throughout a site demystifies the viewing experience and adds litter to an otherwise attractive venue much to the chagrin of site administration and viewers. Additionally, these physical triggers could be easily lost or forgotten, causing some activations to effectively disappear.

Prior approaches involve recovering the anchor in the real world without greater context. Prior anchor technology was developed for the purpose of anchoring virtual content in the real world at the anchor. In prior implementations, there is a one-to-one (1:1) relationship between the anchor and the content. Prior approaches recover an object's location but do not recover the virtual coordinate space relationship to the physical world.

While some prior art visual positioning approaches use a user's position to determine which content to deliver to a device, they do not spawn the user within a virtual map of the site where only the augmented reality activations are visible. These prior art approaches are also discreet, and they are not as accurate or scalable as desirable. Because GPS has a margin of error measured in tens of meters, when the content is being delivered to a user without being referenced to a virtual source of truth, its positioning can be significantly different than intended. Moreover, because the content location resolution is not referenced within the context of a site, placement can overlap with no consideration for what else is nearby. This problem is exacerbated by the GPS margin of error. Finally, the lack of a virtual map of all of the augmentation can make finding activations difficult and result in loss.

It is desirable to spawn a user within a virtual map of the site where only the augmented reality activations are visible. Rather than deliver virtual content to a user, it is also desirable for the user to be delivered to a virtual space where the content exists.

Further, it is desirable to have a system with a subtlety that eliminates the need for extraneous markers.

Therefore, it is desirable to create a system and method for use across mixed reality, desktop, web, and mobile platforms for connecting digital and physical spaces that overcomes these limitations.

### BRIEF SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

A connected space (“connected space”) is any combination and/or augmentation of one or more physical worlds and/or digital worlds, to allow one or more individuals to participate in the resulting spatial experience. Whether physically co-located or geographically dispersed, the connected space can be singularly, continually, or periodically consumed by one or more users at the same time, during overlapping times, or at different times, either synchronously or asynchronously.

This invention and disclosure provide a digitization of the places and objects in the physical world that will connect the physical and digital worlds and make a connected space accessible anywhere in real-time.

This invention and disclosure can be used for a connected space that makes the same content as in the physical world accessible through augmented reality (“AR”) devices by turning off the digital twin environment layer and matching the digital content layer to the physical world. The physical site can be augmented with smart layers where the matching digital content layers align with the physical world.

This invention and disclosure can be used with a “digital twin” to allow the AR Cloud content to become accessible remotely in a connected space.

A system and method are disclosed to create a connected space that is accessible collaboratively from personal computers, mobile phones, or immersive devices.

A visual positioning system and method are disclosed for AR, VR, MR, and XR-connected spaces. The purpose of the visual positioning system and method is to provide an accurate way of deploying and consuming augmented reality activations distributed across a massive real-world site using only naturally available features. The disclosed visual positioning system differs from known systems in that it uses an inside-out approach. Using an accurate 3D model of a site, the user's camera is spawned within the virtual site at the location that correlates to the physical location where the camera is at that time.

To place an activation, an author scans their desired physical location for feature points and aligns those scans and the anchor within the 3D model so the model's position, orientation, and scale match the physical location.

This gives the anchor a coordinate space within the model and saves the anchor in a cloud database alongside metadata that establishes the time of day and the health of the anchor. With established anchors in place, the system can accurately determine the position of a user's camera by combining GPS data, time data, and relevant feature points being scanned by the user's camera. Finally, that user's camera is placed as a virtual camera with respect to the particular anchor within the 3D model allowing the user to see the relevant activation at the user's location.

One unique feature is that anchors are used to recover a user's absolute location and orientation in a digital coordinate space rather than only determining which virtual content is being sent to a user's camera feed. Secondarily, the system does not require non-discrete markers to trigger the activations. Delivering the user's camera to a virtual space that contains all of the activations within a site provides several advantages in subtlety, accuracy, and scalability. As this approach does not require artificial triggers for the augmentations, such as QR codes or symbol patterns, the augmentations can coexist without disrupting a site. Additionally, the alignment of those anchors within a 3D model provides much more accurate positioning for users on the site. Because all of the anchors are placed within a virtual map each anchor becomes easier to manage and harder to lose, allowing for far more content to be placed on site. Because there is not a 1:1 correlation between anchors and items, a large number of virtual items can be available with very few anchors, reducing complexity in authoring, maintenance overhead, data transfer during use, and computational power during resolution.

Accordingly, one or more embodiments of the present invention overcomes one or more of the shortcomings of the known prior art.

For example, in one embodiment, a. visual positioning system for a connected space is disclosed comprising: a three-dimensional model of a physical site; an imagery of the physical site; a three-dimensional model of a physical site; at least one feature point in the plurality of images or video; at least one anchor in the three-dimensional model of the physical site; metadata associated with the at least one anchor; and wherein the visual positioning provides for accurately deploying and consuming augmented reality activations distributed across the physical site using naturally available features.

In this embodiment, the system can further comprise: wherein the three-dimensional model created using the imagery of the physical site; wherein the imagery is captured in real time; where in the three-dimensional model is created using the imagery of the physical site; wherein the three-dimensional model of the physical site comprises a digitally modeled version of the physical site; wherein the three-dimensional model of the physical site comprises a captured version of the physical site; wherein the imagery of the physical site comprises a plurality of images; wherein the imagery of the physical site comprises a video; or further comprising a physical camera at a location in the physical site wherein the imagery of the physical site is provided by the physical camera.

In another example embodiment a method for visual positioning for a connected space is disclosed comprising: providing a physical camera at a location in a physical site; providing a three-dimensional model of the physical site; scanning the physical site using the physical camera to locate at least one feature point; aligning a result of the scanning with an anchor within the three-dimensional model of the site; associating metadata with the anchor; determining the location of the physical camera; and placing a virtual camera with respect to the anchor in the three-dimensional model to allow visualization of the relevant activation at the location of the physical camera.

In this embodiment, the method can further comprise: providing a location determining component; wherein the location determining component is a global positioning system (GPS); wherein the location determining component is a compass; wherein the location determining component is an inertial measurement unit (IMU); wherein determining the location of the physical camera further comprising: determining one or more coordinates of the location of the camera using the location determining component; and determining an orientation of the camera using the location determining component;

In another example embodiment a method for visual positioning for a connected space is disclosed comprising: providing a physical camera at a location in a physical site; determining the location of the camera; retrieving a digital twin model that includes the location in the physical site; viewing the physical site using the physical camera; overlaying the digital twin model over a real-world view provided by the physical camera; adjusting the digital twin model to align it with a corresponding object in the real-world view; and defining and placing at least one anchor in an area within the real-world view.

In this embodiment, the method can further comprise: resolving the anchor to determine an anchor identifier (ID) for the anchor and sharing the anchor ID and the location with a spatial data service; wherein the resolving the anchor to determine an anchor identifier (ID) for the anchor further comprises determining whether one or more previously authored anchors are within a first radius of the anchor, retrieving one or more previously authored anchors, initialize a resolving process with a cloud anchor service, adjusting a correlation between a digital coordinate space and one or more real-world coordinates until an orientation of the camera orientation and a position of the camera match the location in the physical site; wherein the first radius of the anchor is less than 100 meters; wherein the first radius of the anchor is less than or equal to 100 meters and great than or equal to 10 meters; or wherein the first radius of the anchor is less than or equal to 10 meters.

In another example embodiment a method for anchor resolution for a connected space to recover the position and orientation of a camera in relation to a physical world is disclosed comprising: determining an estimate of the location and orientation of the camera using a location determining component GPS and/or a compass application; querying a data service for at least one anchor within a first radius of the estimate of the location and orientation; receiving at least one anchor that is within the first radius of the estimate of the location and orientation; sharing the anchors that are within the first radius of the estimate of the location and orientation with a cloud anchor service; receiving a position and orientation vector relative to the camera for at least one anchor; and inverting the vector to derive the position and orientation of the camera with respect to the physical world.

In this embodiment, the method can further comprise: wherein the first radius of the anchor is less than 100 meters; wherein the first radius of the anchor is less than or equal to 100 meters and great than or equal to 10 meters. wherein the first radius of the anchor is less than or equal to 10 meters; wherein the position vector location determining component is a global positioning system (GPS); wherein the location determining component is a global positioning system (GPS); wherein the location determining component is a compass; or wherein the location determining component is an inertial measurement unit (IMU).

In another example embodiment a method for visual positioning for a connected space is disclosed comprising: providing a three-dimensional model of a site; creating a virtual site; adding anchors to the virtual site; and spawning a camera in the virtual site.

Other objects, features, and advantages of the present invention will become apparent upon consideration of the following detailed description and the accompanying drawings.

### BRIEF DESCRIPTION OF THE DRAWINGS

FIG. 1 illustrates a platform for coherently managing real-time user interactions between the virtual and physical items, character bots, and other human participants, whether in VR, AR, MR, or XR.

FIG. 2 shows an example embodiment of a coordinate system.

FIG. 3 shows an embodiment of a cloud hosted services system overview diagram.

FIG. 4 shows a visual positioning system block diagram for an example embodiment.

FIG. 5 shows a visual positioning flowchart for an example embodiment.

FIG. 6 shows a flowchart of an example embodiment of anchor algorithms and computer vision algorithms.

FIG. 7 illustrates correlated physical and digital content for an example embodiment.

FIG. 8 illustrates the Visual Positioning system sequence for an example embodiment.

FIG. 9 illustrates an example embodiment of a positioning service.

FIG. 10 shows an AR app tracking abstraction for an example embodiment.

### DETAILED DESCRIPTION OF THE INVENTION

The following is a detailed description of embodiments to illustrate the principles of the invention. The embodiments are provided to illustrate aspects of the invention, but the invention is not limited to any embodiment. The scope of the invention encompasses numerous alternatives, modifications, and equivalents. The scope of the invention is limited only by the claims.

While numerous specific details are set forth in the following description to provide a thorough understanding of the invention, the invention may be practiced according to the claims without some or all of these specific details.

Various embodiments will be described in detail with reference to the accompanying drawings. References made to particular examples and implementations are for illustrative purposes and are not intended to limit the scope of the claims.

### Platform 100 Overview

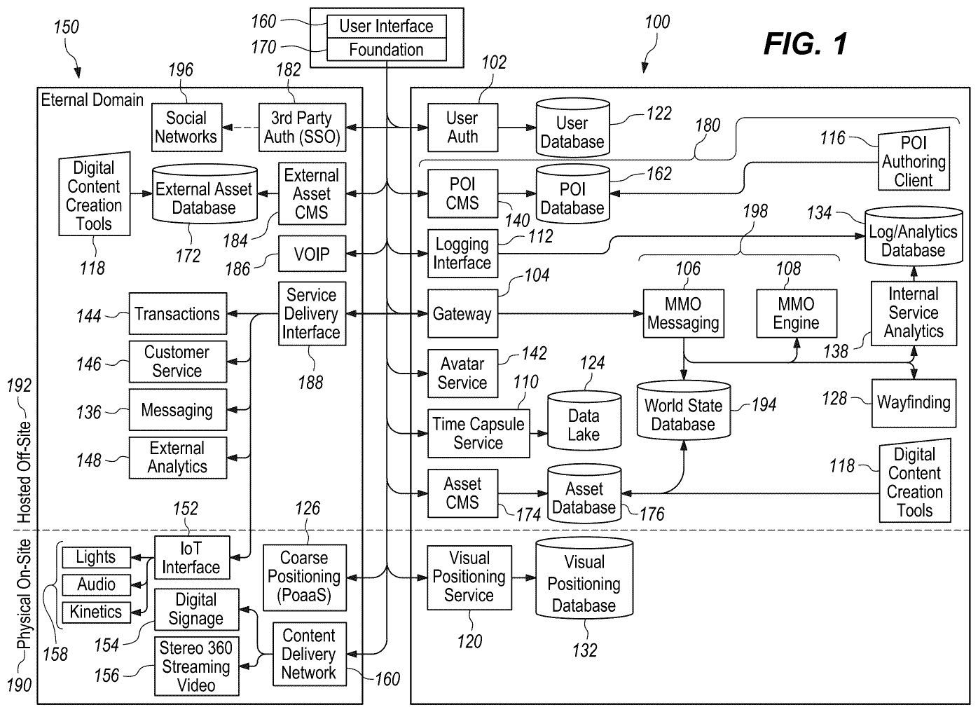

As shown in FIG. 1, Platform 100 according to the present invention is a technology platform that allows users to design, build, and operate a connected space that bridges physical and/or digital spaces. Platform 100 powers XR experiences to be accessed by users anywhere in the world at any time. It allows multiple users to collaborate in the design and review process, such as when designing a real-world location of interest and simulated mission.

In one embodiment, Platform 100 hosts all content and logic designed to operate the connected space, enabling end-users to conduct activities (e.g., whether consumers engaging with experiences or enterprise users with operational activities) within Platform 100. Platform 100 also can gather data from trainee performance in missions and easily adjust elements within the missions to create additional operational scenarios. Platform 100 can import a “digital twin” anchored in a real-world location with geographically contextualized data. Because there is not a 1:1 correlation between anchors and items, a large number of virtual items can be available with very few anchors, reducing complexity in authoring, maintenance overhead, data transfer during use, and computational power during resolution.

Platform 100 comprises a user authentication service 102, gateway 104, MMO messaging 106, MMO engine 108, time capsule service 110, logging interface 112, Point-Of-Interest (POI) system 180, avatar service 142, and Visual Position Service (VPS) 120. The Magnopus World Services Platform is an example of Platform 100. MMO services 198 comprises MMO engine 108 and MMO messaging 106. Internal analytics can be done by internal service analytics 138 using log analytics database 134.

In one example embodiment, Platform 100 allows visualization of assets and mission components as trainers design operational challenges for trainees. Platform 100 can publish and make available to operate the connected space, enabling end users to conduct activities (e.g., whether consumers engaging with experiences or enterprise users with operational activities) within Platform 100. It also can gather data from trainee performance in missions and easily adjust elements within the missions to create additional operational scenarios.

External services 150 are either located at physical on-site 190, which is the physical site of the visitors, or located at hosted offsite 192, such as a cloud environment. IoT infrastructure 158, coarse positioning 126, and digital signage 154 and audio/video streaming 156 are located at the physical on-site 190. In one embodiment, third party authentication service 182, external asset CMS 184, VOIP 186, and service delivery interface 188 are located at hosted offsite 192. In one embodiment, third party authentication service 182 is used to authenticate social networks 196. In another embodiment, service delivery interface 188 can be used for interaction with external services 150 such as transactions 144, messaging 136, customer service 146, and/or external analytics 148.

In one embodiment, external services 150 can be a smart environment that responds to visitors through user interface 160, which in various embodiments can comprise an AR and/or VR interface, mobile apps, web applications, desk and other devices that respond to visitors.

The AR and social capabilities can connect to the IoT infrastructure 158 via IoT Interface 152 of external services 150. In one example, this is built on a 5G infrastructure. In one example, humans, avatars, and AI characters can interact. The people, characters, and even objects can interact. Interaction is non-linear, mirroring the real world. For remote visitors, PC or mobile applications, including VR, grant access to the connected space where the remote visitors can connect with the physical content and on-site visitors. VOIP 186 and content delivery network 160 can connect visitors in the physical world with those attending virtually via digital signage 154 and audio/video streaming 156.

Platform 100 provides cross-device flexibility, allowing access to the same connected space across multiple devices, including VR, desktop, mobile (2D and AR), and web. All updates to the core connected space are automatically updated for all devices.

Platform allows real-time social and multiplayer interaction. Users can interact intuitively with other users with highly-naturalistic social mechanics.

Platform 100 implements the functionality necessary to create a digital twin of a physical location. Platform 100 populates the location with digital elements including architectural geometry, virtual items, and automated characters via world state database 194 and avatar service 142. Platform 100 coherently manages real-time user interactions between the virtual and physical items, character bots, and other human participants, whether in VR, AR, MR, or XR.

The user authentication service (UAS) 102, user data base 122, and third party authentication service 182 provides support for multi-tiered access to the services for a connected space and abstracts and extends the functionality of any underlying, full-featured User Access Management (UAM) system. In addition to full user authentication and authorization, UAS 102 also allows anonymous and stateful, non-personally identifiable information (PII) user access from user database 122. UAS 102 is responsible for granting tokens and managing access to the appropriate backend services for each tier of user. UAS 102 is able to automatically migrate user accounts from anonymous and non-PII accounts to full UAM accounts without additional user intervention.

Gateway 104 enables a transparent connection between user application requests and the appropriate backend services. Gateway 104 is responsible for automatically provisioning and deploying new services, scaling existing services, and removing unused services based on user demand. Through, for example, a uniform RESTful API, Gateway 104 implements reverse proxy, port redirection, load balancing, and elastic scaling functions. Gateway 104 provides a simple, deterministic interface for user access and resource management, masking the underlying complexity of the service architecture.

Massive multiplayer online (MMO) Messaging106 is the robust data routing and communication layer for the broader set of services that are a collection of loosely coupled microservices. The microservice architecture provides several key advantages over a monolithic solution including ease of maintenance, extensibility, continuous deployability, abstraction of complexity, and scalability. However, in order to gain the advantages of a microservice solution, the MMO Messaging 106 implements a standalone, scalable message passing interface with a strictly defined, but abstract and simple, protocol for defining message sources, destinations, types, and payloads. MMO Messaging106 can rapidly inspect message metadata and ensure all messages are delivered to the intended recipients. MMO Messaging 106 is the nervous system of Platform 100.

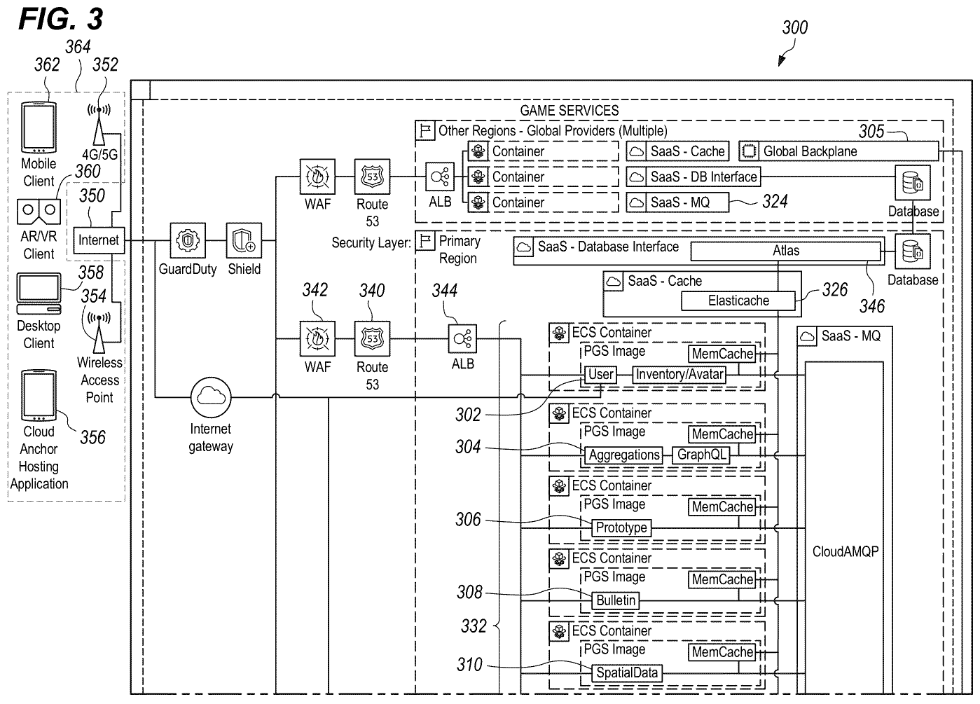

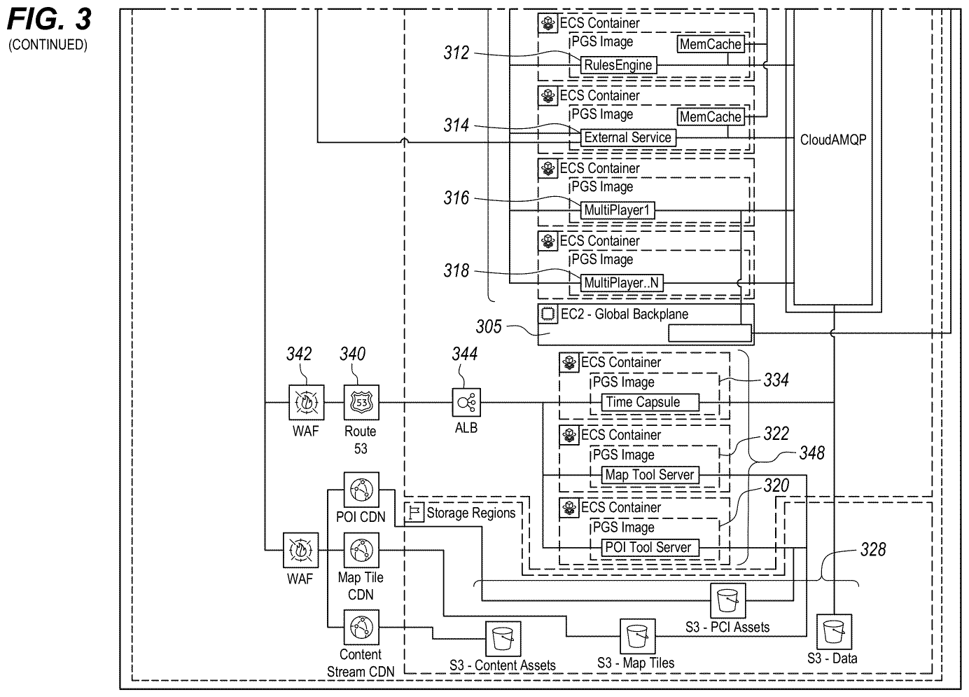

MMO Engine 108 is a collection of loosely coupled microservices 332 (FIG. 3) that enable a massive persistent, shared world space for arbitrary numbers of simultaneous and asynchronous users. MMO engine 108 utilizes multiplayer technology that governs seamless interactions between users. MMO engine 108 enables scaling up of users within Platform 100 and driving multiplayer interactions.

MMO engine 108 is extensible in order to support future requirements. MMO engine 108 comprises several core components including in one example embodiment as shown in FIG. 3 object prototype services 306, user management services 302, multiplayer services 316 and/or 318, and spatial data services 310. User management services 302 implements support for stateful user information such as inventory and history. Object prototype services 206provides abstract, non-user object prototype and world object instantiation functionality. Multiplayer services 316 and/or 318 maintains the real-time state of users and objects by geographic region, and broadcasts location and state changes to all other users and objects in the region.

Through the collection of microservices 332, though users may enter and exit the world at will, the overall state of the world remains synchronous and persistent. In addition, client applications are able to request classes of world elements relevant to their function. For example, virtual reality applications would request all geometry in the world, but augmented reality applications would only need user and transient object geometry. MMO Engine 108 provides the core components for maintaining a common, interactive world to all users.

Time Capsules are a unique method of allowing participants to take away a tangible memento of their time in a connected space that is experienced in VR, AR, MR, or XR. Time Capsules are graphical timelines of the users' journeys through the connected space, complete with personal pictures and text of the experience. Time Capsule Service 110 facilitates this by capturing, contextualizing, and storing the artifacts of an attendee's journey in data lake 124. Once the user leaves the connected space, the service generates a visual summary and presents it to the user so that they can continue to access and relive their journey.

Platform 100 further comprises POI (Point of Interest) authoring client 116 and digital content creation tools 118. The digital world is only engaging if it is populated with content. The world content is divided into two primary classes: Points of Interest and World Data. The system includes POI authoring client 116 and digital content creation tools 118 for creating each class of content.

In an example embodiment, the world space is stocked with real world points of interest, from artwork to architecturally significant structures, and from historically significant artifacts to culturally significant elements. POI (Point of Interest) Authoring Client 116 provides the interface to define these elements and their associated metadata. POI Authoring Client 116 is also a graphical map interface with UX elements for adding, modifying, and deleting points of interest and individual metadata fields. POI Authoring Client 116 manages the definition of relations for existing, network accessible metadata as well as the uploading of content to the POI database 162.

For world items that are not authored in POI authoring client 116 the digital content creation tools 118 provides the interface for defining them. These items include items such as building geometry, landscape components, architectural detail, civil structures, digital signage 157, and site decoration. The digital content creation tools 118 allow authors to associate assets in the asset database 176 and external asset store database 172 with their positions in the digital world space. The client also manages the uploading of digital assets to the asset database 176 and external asset store database 172. The client includes a fully immersive interface for interacting with the total world space, such as in VR.

User interface 160 comprises the user-facing elements of Platform 100, and it is the portal through which users interact with the world and other users. Through various presentation models including VR and AR on multiple devices such as mobile, desktop, and wired and standalone HMDs, users employ natural interactions using familiar interfaces such as 6Degrees of Freedom (DOF) controllers and thumbsticks. Since user interface 160 is the way general users experience this world, the usability and enjoyability of them is critical. User interface 160 is built on top of foundation 170, and communicating in real time and retrieving the world elements on demand from MMO engine 108 to aid in creating a seamless experience.

Platform 100 is an architecture that can support an extremely large and complex environment. Given that there is a finite capability in the devices running the end user applications, a world with infinite complexity would not be possible to represent. The client applications include renderer functions that work in conjunction with the backend services and visualization capabilities to present a convincing immersive experience for the user with the essential and relevant data and representations for that user.

Foundation 170 abstracts and unifies all the functionality necessary to provide a seamless, networked immersive user experience. It includes a developer interface to build the user experiences and the libraries to deploy the experiences to the user-facing applications. It coordinates the communication between the abstract backend world representation and the in-experience user-facing environment. Foundation 170 is the bridge between the world state and the human computer interface.

To provide a believable and effective augmented reality for users to collaborate within, concrete anchors to the absolute physical world coordinate space are used. Users must be able to see the same things in the same place at the same time, and experience the results of interactions as they occur. The VPS 120 abstracts the generalized functionality and in an example embodiment, interfaces with third party systems. In addition, as systems evolve, and new approaches emerge, they can be easily integrated without need to rebuild the abstract interface.

Geo-contextualized data stored in VPS database 132 is incorporated by the VPS 120. Content and experiences in connected spaces are mapped to real-world locations with high accuracy, such as centimeter-level accuracy. Visual Positioning System 120 streams in relevant data feeds like IoT devices or other equipment and sensors to create additional contextually relevant experiences within the connected space.

POI system 180 comprising POI CMS 140, POI Authoring Client 116, and POI database 162 allows Platform 100 to place content and experiences within a “map” of the digital twin.

As the complexity of the world expands and the number of users grows, the data transfer requirement expands exponentially. An action by a single user or interaction with a world element must be broadcast to all other users within a given proximity in real-time. To accomplish this without overwhelming the abilities of the user devices and available network bandwidth requires sophisticated numerical packing and statistical evaluation of the shared data to ensure that the appropriate transforms are shared, but that non-critical data is reserved, delayed, or discarded. The transit logic and distribution system are part of MMO messaging 106 and MMO engine 108. The transit logic and distribution system comprise the adaptive, intelligent transport system and are critical to the success of the world experience because the assist with data conservation, bandwidth conservation, and other resource conservation.

In an example embodiment, Platform 100 handles dynamic content, allowing the import and export of environments and assets across multiple standard 3D and 2D file types while scenarios are running.

In an example embodiment, Platform 100 provides customizable experiences by defining rules that power events, activities, and exercises that govern a connected space.

In an example embodiment, Platform 100 provides data analytics that track user activities and experiences across the connected space. It gathers aggregate data in a dashboard to analyze user activities.

Foundation 170 provides the capabilities for Platform 100 to be game-engine agnostic. In an example embodiment, Unity and Unreal plugins allow developers to use either engine and still collaborate with users in the other engine. This device-agnostic approach accommodates collaboration across different projects, teams, and partner workflows into the same platform.

In one example embodiment, the system architecture includes a 5G network and Wi-Fi access points to PoP connections via service delivery interface 188 and gateway 104 to hosted off-site services 192; visitor positioning via VPS 120, course positioning 126, and wayfinding 128; mobile to IoT systems integration via IoT interface 152; site-wide integrated display via VOIP 186 and content delivery network 160 comprising digital signage 154 and audio/video streaming 156; digital twin capability via world state database 194 and avatar service 142; external asset CMS 184, external asset database 172, POI CMS 140, POI database 162, asset CMS 174, and asset database 176 for bridging AR and VR users; large scale cross-platform communication via gateway 104 and user interface 160; and MMO engine 108 for visitor experience

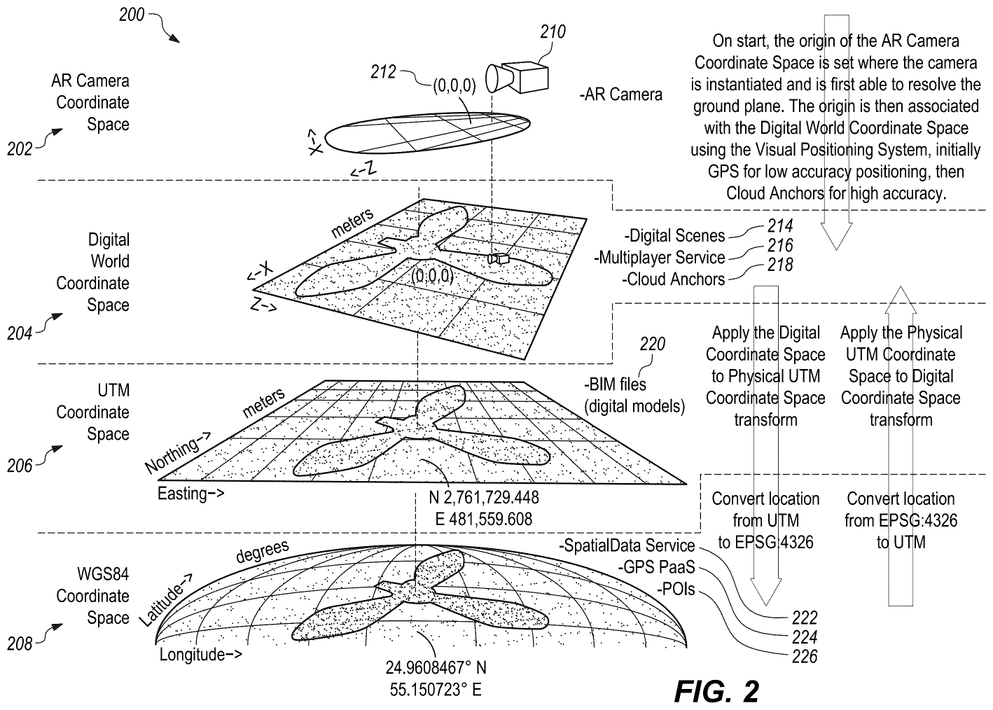

FIG. 2 illustrates an example embodiment of a coordinate space 200. Coordinate space 200 is a parameterized representation of a spatial environment. Coordinate space 200 comprises an AR camera coordinate space 202, a World Coordinate Space 204, a UTM coordinate space 206, and a World Geodetic System 1984 (WGS84) coordinate space 208. An AR camera 210 is in the AR camera coordinate space 202. Scenes 214, multiplayer service 216 and cloud anchors 218 are in the World Coordinate Space 204. Building information modeling (BIM) files 220 (site art or digital models) are in the UTM coordinate space 206. Spatial data service 310, GPS PaaS 224, and POIs 226 are in the WGS84 coordinate space 208.

VPS 120 is responsible for mapping geospatial coordinates to arbitrary digital coordinate spaces. This is accomplished through the use of cloud anchors 218 which encapsulate the point and orientation map between a geospatial coordinate and the corresponding digital coordinate. Once resolved, the coordinates 212 can be mapped and the relationship between the spatial environments can be derived.

In this example embodiment, on start, the origin of the AR camera coordinate space 202 is set where AR camera 210 is instantiated and is first able to resolve the ground plan 212. The origin is then associated with coordinate space 204 using either GPS 264 for low accuracy positioning or cloud anchors 218 for high accuracy.

FIG. 3 illustrates an example system architecture for the cloud hosted services (CHS) system 300. In one embodiment, CHS system 300 is hosted on Amazon Web Services, but in other embodiments, may be adapted to most modern cloud service providers. CHS system 300 comprises multiple, loosely coupled micro-services 332. In one embodiment, these micro-services 332 comprise user management services 302, service aggregations 304, object prototype services 306, notification bulletin 308, spatial data services 310, rules engine 312, external service 314, and multiplayer services 316 and 318. In one embodiment, spatial data service 310 comprises cloud anchors for visual positioning and POI data. Microservices 332 are containerized and scalability is managed through a container service, such as in one example embodiment the AWS Elastic Container Service (“ECS”).

Also hosted within CHS system 300 are management and operational tools 348 comprising a POI tool service 320, user tracking map tool service 322, and time capsule tool service 334. In one embodiment, for efficient internal communication, CHS system 300 relies on SaaS solutions, such as in one embodiment RabbitMQ 324 for non-realtime services and a global Redis cluster 326 for real-time, low latency services. Persistent data is stored in database 328, such as a MongoDB database. Caching is facilitated through Redis cluster 326. Management and operational tools 348 are also containerized and scalability is managed through a container service 330, such as in one example embodiment the AWS ECS.

User-facing data is stored in storage 328 separately from system logic. This allows for more efficient storage and delivery of data through a content delivery network while maintaining the flexibility of a referential, decoupled logic layer. Data can be updated and versioned independently of the referring logic.

Service REST and WebSocket interfaces are available to Internet-connected clients through proxied load balancer 344. Load balancers 344, WAF 342 and resolvers 340 route traffic to microservices 332 and management and operational tools 348 based on a real-time load of the microservices 332 and management and operational tools 348. Messages are forwarded through global backplane 305, which is connected to multiplayer services 316 and/or 318.

Non-realtime services support stateless REST interfaces for user management services 302, service aggregations 304, object prototype service 306, spatial data service 310, rules engine 312, and external service 314. Real-time, low latency services support stateful WebSocket and SignalR interfaces for notification bulletin 308 and multiplayer services 316 and 318. External clients 364 may include mobile 362, web desktop 358, AR/VR/XR 360, and cloud anchor hosting applications 356. The only requirement for using CHS system 300 is an Internet connection 350, whether through wired, wireless 354, or mobile 4G/5G/nG networks 352.

In various embodiments, CHS system 300 services may be deployed in any of a shared tenancy, dedicated, or on-premises model. CHS system 300 services may also be directly connected to external sites and networks, such as in one embodiment through AWS Direct Connect. CHS system 300 services may also optionally be integrated with external SaaS solutions, such as Google Cloud Anchors or Google Firebase.

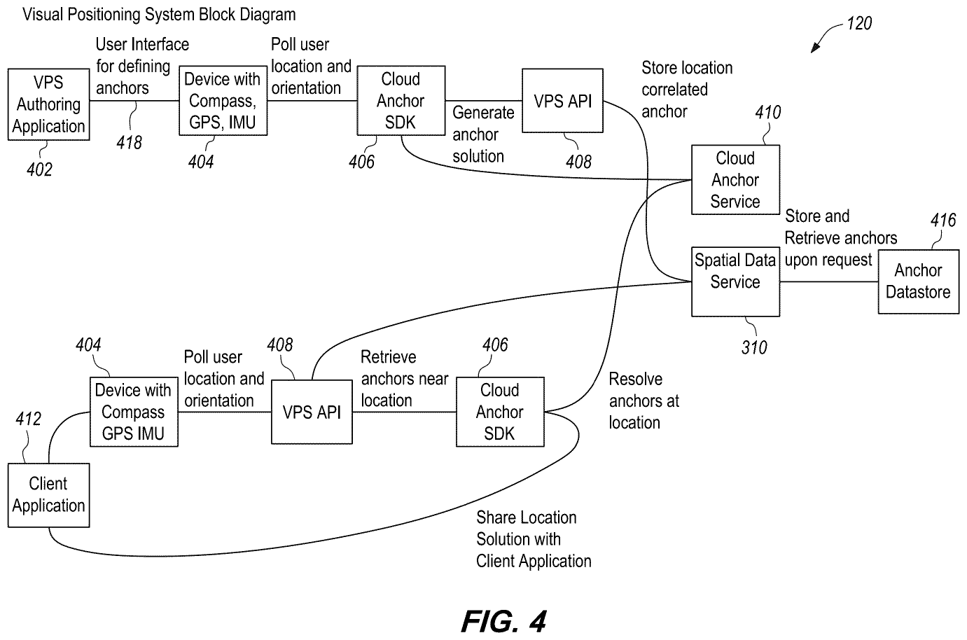

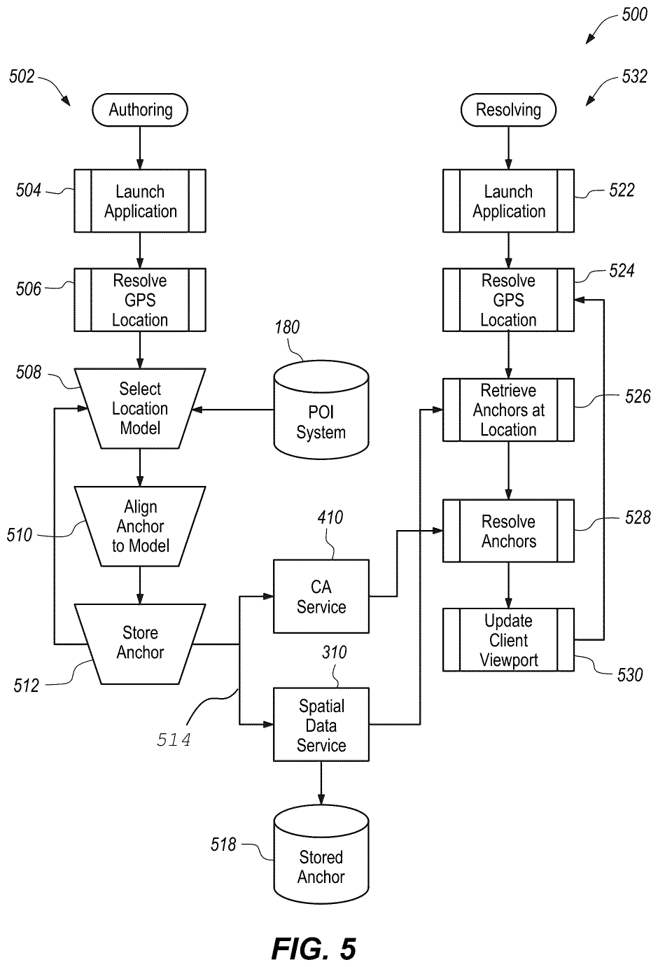

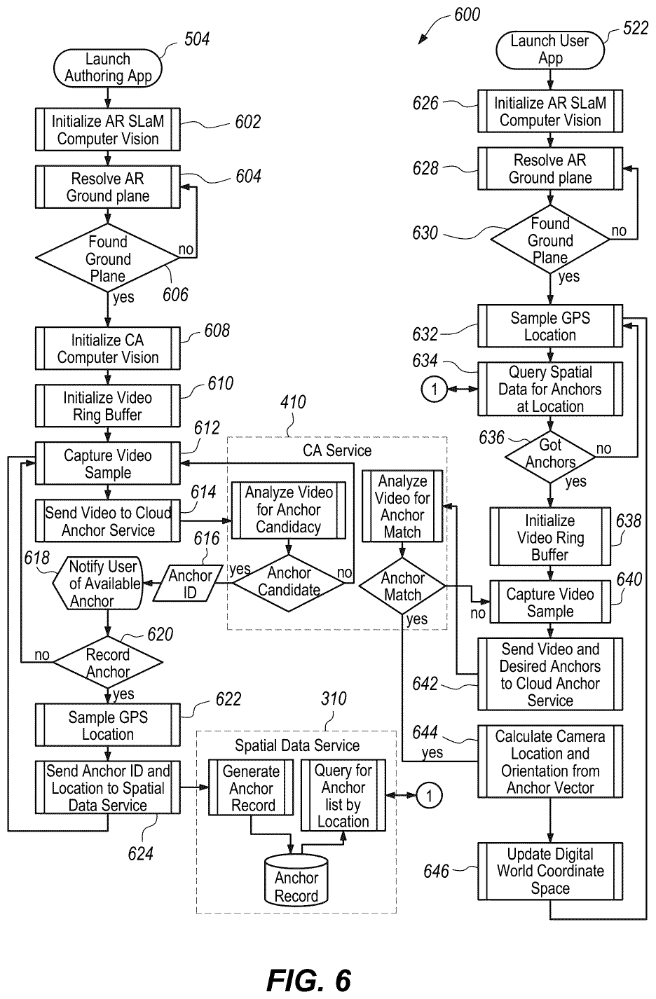

FIG. 4 shows a block diagram for an example embodiment of VPS 120. FIG. 5 shows VPS flowchart 500 for the example embodiment. FIG. 6 shows flowchart 600 for VPS anchoring algorithms and computer vision algorithms for the example embodiment.

As shown in FIGS. 4, 5, 6, and 8, VPS 120 supports two different modes of operation: anchor hosting mode 502 and anchor resolution mode 532. In this example embodiment, both anchor hosting mode 502 and anchor resolution mode 532 share the same underlying systems and leverage the same application library. A primary function of VPS 120 is to provide the ability to recover the real-world location of an AR application. This is accomplished by hosting visual anchors that are correlated with real-world geographic locations and which can be retrieved and matched against a device's camera view in real-time using computer vision algorithms.

VPS 120 is a critical component when using a Platform 100 application that requires users to interact with digital objects in a physical world. In order to represent digital objects in the proper relationship to the user when viewed through an AR camera, the position of the user's camera must be recovered. This is a multi-step process.

When the application is launched, the GPS and compass component of the position system is queried to determine the rough location and orientation of the device. The generic AR Simultaneous Localization and Mapping (SLaM) component is then initialized and commences resolving the ground plane relationship to the camera. Once the ground plane is resolved, the visual positioning system can engage in anchor placement or resolution. If the application is an anchor authoring application, the authoring mode is started. Alternatively, if the application is an anchor resolution application, the resolution mode is started.

When in anchor authoring mode, the goal is to place anchors that can later be used to determine the user's position through anchor resolution. In this mode, the application first retrieves a low-resolution digital model of the surrounding environment from the POI system 180 using the rough location retrieved at the start of the process. A semi-transparent rendering of the model is composited over the AR camera view. The author then manipulates the model, optionally with assistance from the auto-alignment system, until the model visually coincides with the real-world camera stream. When the digital and physical models are aligned, the author defines anchors in the surrounding environment. If the cloud anchor service accepts the anchors as valid, the anchors are then recorded with spatial data service 310 and correlated to the rough location. This process continues until the space is parameterized.

In an embodiment of the disclosed invention, anchors are leveraged to incrementally build an absolute relationship between a physical world and a digital coordinate space, thereby allowing placement of an arbitrary number of virtual content objects that will appear in their appropriate locations for all participating users simultaneously. In addition, it is possible to change the content without having to change the anchors. Unlike prior system and methods that recover an object's location, and this system and method recover the virtual coordinate space's relationship to the physical world.

When in anchor resolution mode, the goal is to recover the position and orientation of the user's device in relation to the physical world. The system queries spatial data service 310 for anchors that are within a given proximity of the location retrieved at the start of the process. Any stored anchors are returned to the application. The system then enters the discovery loop and shares the retrieved anchors with the cloud anchor service. If the cloud anchor service is able to resolve any of the anchors of interest, it notifies the application of the anchor's position vector in relation to the device's camera. The VPS inverts the anchor position vector and derives the position and orientation of the user's device with respect to the real world. This process continues while the application is active.

As shown in FIG. 4, Visual Positioning System 120 comprises a VPS authoring application 402, a device 404 comprising any of a compass, a GPS, and an IMU, a cloud anchor SDK 406, a VPS API 408, a cloud anchor service 410, spatial data service 310, an anchor database, and a client application 412.

VPS authoring application 402 communicates with device 404 providing a user interface 418 for defining anchors. For authoring, device 404 communicates with cloud anchor software SDK 406 to poll user location and orientation. Cloud anchor SDK 406 generates an anchor solution that is communicated to a VPS Application Programming Interface (API) 408. Cloud anchor SDK also communicates with cloud anchor service 410. The cloud anchor service receives the resolution artifacts, such as pictures, video segments, and sensor data, and returns the vector from the device to the anchor, if an anchor is found within the resolution artifacts.

VPS API 408 communicates with a spatial data service 310 to store the location of a correlated anchor. Spatial data service 310 communicates with anchor datastore 416 to store anchors upon request.

Client application 412 also communicates with device 404. On behalf of client application 412, device 404 communicates with VPS API 408 to poll user location and orientation. VPS API 408 then communicates with cloud anchor SDK 406 to retrieve anchors near the user location. Cloud anchor SDK shares the location with client application 412 and provides the resolution artifacts, such as pictures, video segments, and sensor data to cloud anchor service 410 to resolve anchors at the user location.

FIG. 5 illustrates the user experience workflow for VPS authoring. As shown in FIG. 5, authoring process 502 of VPS 120 begins with launching the VPS authoring application 402 at Step 504. The device 404 location is queried in Step 506. Then, in Step 508, VPS authoring application 402 retrieves any digital twin models that are in the vicinity of the location from the POI system 180. In the user interface of VPS authoring application 402, the model or models are onion-skinned over the real-world AR camera view in the VPS authoring application 402. In Step 510, the digital model is adjusted until it is aligned with the corresponding real-world object. Once the digital and physical models are aligned, in Step 512, an anchor is placed, or stored, into the AR scene. If the anchor is resolved, in Step 514 the device shares the anchor ID and device location with spatial data service 310, which stores the relationship in Step 518 an anchor database. This process continues until the author is satisfied with the anchor coverage.

In Step 522, the VPS authoring application 402 initiates the resolving process. It proceeds to Step 524 where the location of device404 is queried. Once the location is determined, the process proceeds to Step 526. In Step 526, it queries the spatial data service 310 for any nearby authored anchors. In one embodiment, an authored anchor is nearby if it is within less than 100 meters of the location. In another example embodiment, an authored anchor is nearby if it is within 10 meters to 100 meters of the location. In another example embodiment, an authored anchor is nearby if it is within 10 meters of the location. If anchors are available, the system retrieves the anchors and proceeds to Step 528, which initializes the resolving process with the cloud anchor service 410. Once anchors are resolved, the process proceeds to Step 530 to update the client viewport. The correlation between the digital coordinate space within the application and the real-world geographic coordinates is adjusted until the device's camera orientation and position match the physical location. It is then possible to place digital objects with the proper real-world relationship to the user in AR.

FIG. 6 shows a detailed example embodiment of the computational logic for authoring process 502.

As shown in FIG. 6, Step 504 further comprises Steps 602, 604, 608, and 610. In Step 602, the process initializes AR SLaM computer vision and proceeds to Step 604. In Step 604, it resolves AR ground plane and proceeds to Step 606. Step 606 queries whether a ground plane was found. If yes, it proceeds to Step 608. If not, it returns to Step 604.

In Step 608, the process initializes the cloud anchor computer vision algorithm and proceeds to Step 610.

In Step 610, it initializes the video ring buffer and proceeds to Step 612.

In Step 510, the digital model is adjusted until it is aligned with the corresponding real-world object. Step 510 further comprises Steps 612 and 614.

In Step 612, a video sample is captured and then it proceeds to Step 614.

In Step 614, it sends the video sample to cloud anchor service 410. Cloud anchor service 410 analyzes the video sample for anchor candidacy and determines whether there is a valid anchor candidate. If no valid anchor candidate, the process returns to Step 612.

Step 512 further comprises Steps 616, 618, 620, 622, 624.

If there is a valid anchor candidate, the cloud anchor service 410 returns an anchor ID at Step 616 and the process proceeds to Step 618.

In Step 618, the user is notified of an available anchor and proceeds to Step 620.

In Step 620, the process determines whether to record the anchor. If yes, then it proceeds to Step 622. If no, then it proceeds to Step 612. In Step 622, it samples the GPS location and proceeds to Step 624. In Step 624, it sends anchor ID 616 and the sample GPS location to spatial data service 310. Spatial data service 310 generates an anchor record and stores the anchor record.

As shown in the example embodiment of user application in FIG. 6, after user application is launched in step 522, the process proceeds to query the device location in Step 626.

In Step 626, the process initializes AR SLaM computer vision and proceeds to Step 628. In Step 628, it resolves AR ground plane and proceeds to Step 630. Step 630 queries whether a ground plane was found. If yes, it proceeds to Step 524. If not, it returns to Step 628.

Step 524 further comprises Step 632. As Step 632, it samples the GPS location and proceeds to Step 634.

In Step 526, it queries the spatial data service 310 for any nearby authored anchors. Step 526 further comprises Steps 634 and 636. In Step 634, it queries spatial data service 310 for anchors at the GPS location. Spatial data service 310 queries the anchor record for an anchor list by location. Then the process proceeds to Step 636. In Step 636, it queries whether there are any anchors available. If no, then it proceeds to Step 632. If yes, then it proceeds to Step 528.

In Step 528, the process initializes the resolving process and retrieves the anchors. Step 528 further comprises Steps 638, 640, 642, and 644. In Step 638, it initializes the video ring buffer and proceeds to Step 640. In Step 640, it captures a video sample and proceeds to Step 642. In Step 642, it sends the video sample and desired anchors to cloud anchor service 410. Cloud anchor service 410 analyzes the video sample for an anchor match. If there is no anchor match, it returns to Step 640. If there is an anchor match, then it proceeds to Step 644. In Step 644, it calculates the camera location and orientation from the anchor vector and proceeds to Step 530. In Step 530, the process updates the client viewport, including the digital world coordinate space.

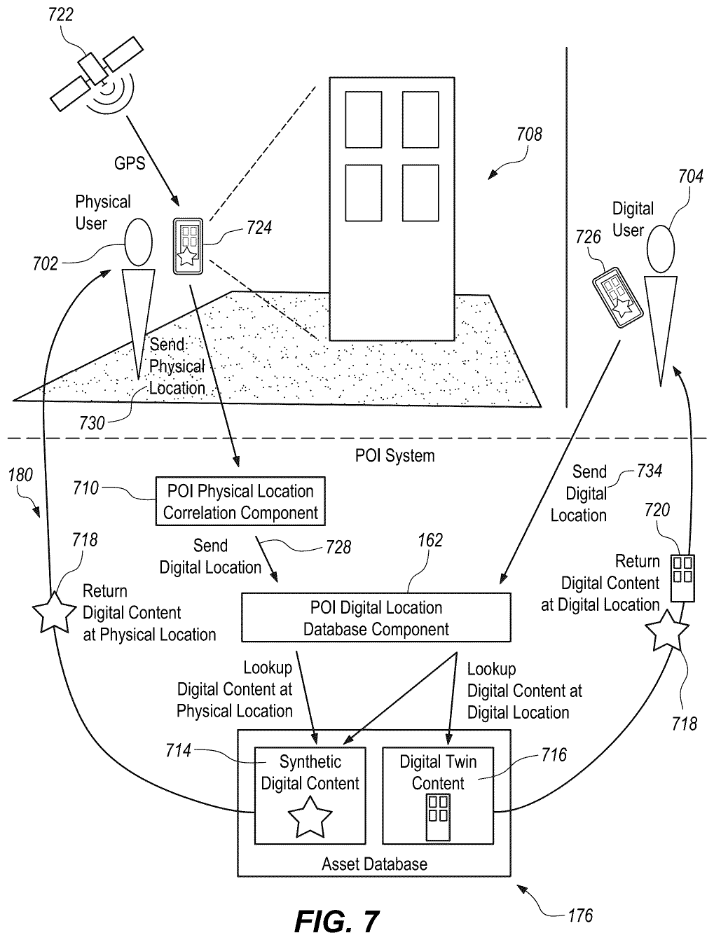

FIG. 7 illustrates correlated physical and digital content. As shown in FIG. 7, point-of-interest (POI) system 180 enables both physical participants 702 and digital participants 704 to see and interact with the same digital content 732. The system forms the bridge between physical locations 208 and correlated digital content 732. Through their appropriate platforms and interfaces, participants are presented with the subset of digital content comprising synthetic digital content 714 and/or digital twin content 716, as appropriate for their modalities. Both digital participants 704 and physical participants 702 see synthetic digital content 714. Additionally, digital participants 704 see digital twin content 716 for the physical locations 708.

Digital twin content 716 comprises one-to-one (1:1) digitally modeled representations of real-world items. These are stored in POI database 162 with the geographic coordinates of the items and pointers to the digital model data. As illustrated in FIG. 7, the models are made available to digital participants 704 when they enter the virtual locations correlated with the physical locations 708.

Synthetic digital content 714, or virtual items, which items that do not exist in the real world, are also stored in the POI database 162, with the exact desired geographic coordinates and pointers to the digital model data. As illustrated in FIG. 7, synthetic digital content 714 is made available to both digital and physical participants when they enter the correlated locations. Because the system stores items referentially, the underlying models may be updated or changed while retaining their spatial relationships. As well, since synthetic digital content 714 comprises virtual items, synthetic digital content 714 is not static and may be programmatically interactive.

Storing temporal information for objects improves network bandwidth and reduces the required resources because, unlike GIS systems, an object is only displayed when the time is correct. For example, sunset is not displayed midday and should not look exactly the same every day, and fireworks can be reserved for holidays and can vary across years and/or locations.

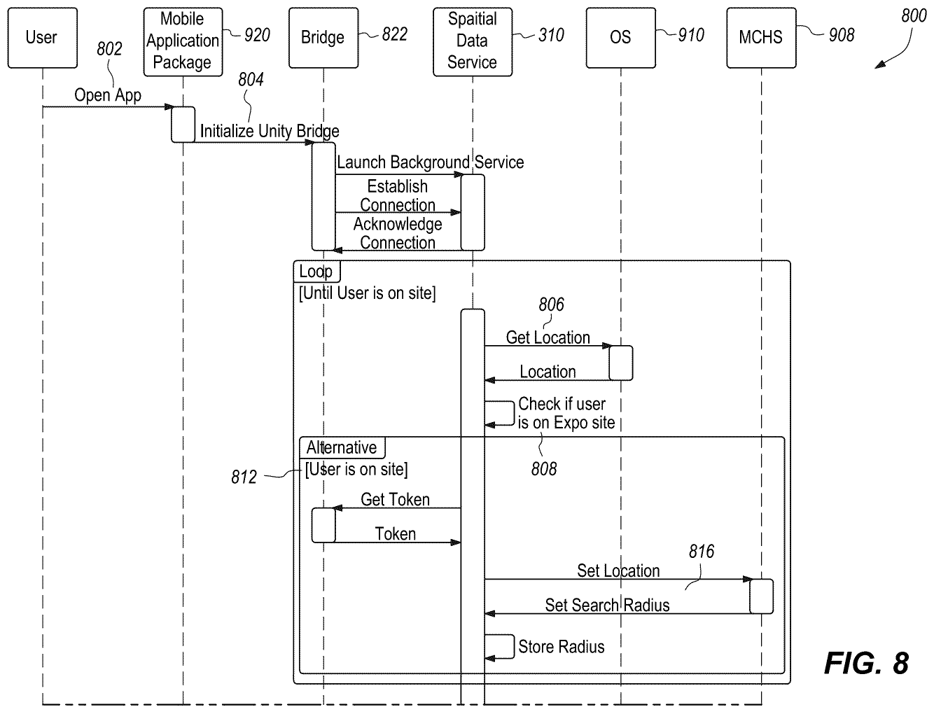

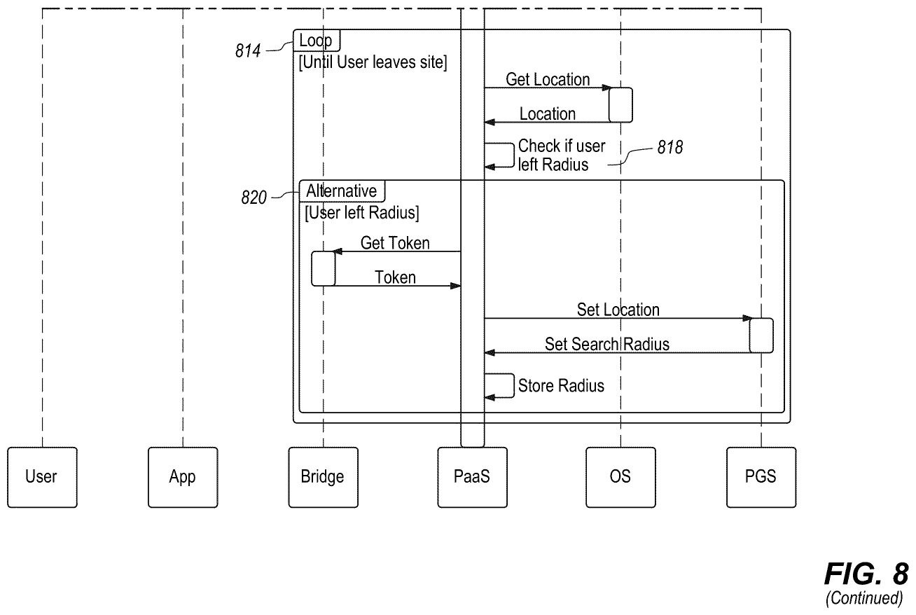

FIG. 8 illustrates the sequence 800 for determining whether to look for anchors or not. To look for anchors the system enters anchor resolution mode. Sequence 800 begins at Step 802 where the application 160 is launched (App). The application initializes the GPS location system on device 822 (Bridge) at Step 804. The device registers with the spatial data service 310. The device location is sampled (OS) at Step 806. At Step 808, the spatial data service 310 is queried as to whether the sampled position is within an area that contains anchors (“on-site”). If the current location is not “on-site” (near anchors), then the device enters a low frequency loop 810 sampling location and checking whether it's “on-site” (first Loop). Once the location is determined to be “on-site” (near anchors) 812, the device enters a high frequency loop 814 where it starts looking for resolvable anchors nearby-within a given radius of the most recently sampled location (first Alternative) 816. While “on-site”, the system remains in a high frequency loop 814 to determine whether it needs to update the anchor search list 818. The search list needs to be updated if the most recent location update placed the device in a new anchor cell (second Loop). If the most recent location sample is determined to be outside all of the anchor cells “off-site” 820, the system returns to the low frequency loop 810 to determine when it again transitions to “on-site” (second Alternative).

To define synthetic items that can be realized in the real world and represent real-world items in the virtual world, the system must unambiguously recover the absolute location and orientation of a user in the system. The disclosed VPS 120 fuses the anchor algorithms and computer vision algorithms shown in FIGS. 5 and 6 to continuously recover the absolute position and orientation of the user's device in order to provide a window between the two spaces. This recovery is bi-directional, so a virtual user can see into the physical world and the physical user can see into the virtual world. As well, the underlying technology is abstracted so future solutions can be added and depreciated solutions can be removed without affecting the top-level interface.

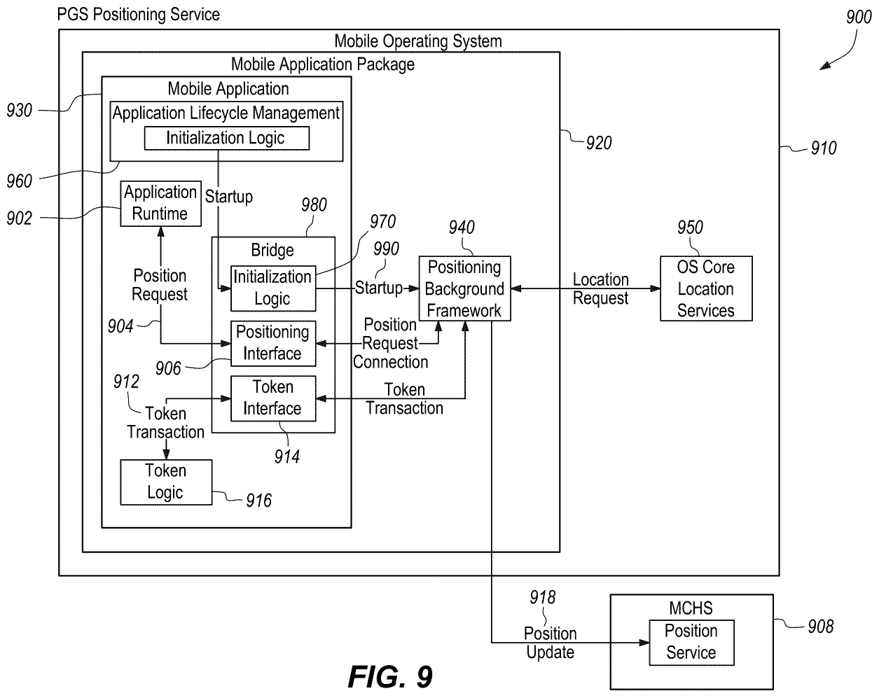

FIG. 9 is the block diagram of the location query logic 900 within the running application 920 (Mobile Application Package). Location query logic 900 is encapsulated in Resolve GPS Location 506 and physical location 730.

When a user starts the application, Mobile Operating System 910 launches the Mobile Application Package 920. Mobile Application Package 920 initializes the Mobile Application 930 and Positioning Background Framework 940. Positioning Background Framework 940 provides a non-blocking interface for the Mobile Application 930 to query the location of the device from OS Core Location Services 950. When Mobile Application 930 is launched, it initializes the Application Lifecycle Management 960, which is responsible for managing the lifecycle of the running application. Initialization Logic 970 in this block initializes the Bridge 980, which then runs its internal Initialization Logic 970. Bridge 980 Initialization Logic 970 establishes a connection 990 (“Startup”) to the Positioning Background Framework 940. While running, Mobile Application's 930 Application Runtime 902 will periodically send a position request 904 requesting the current location (“Position Request”) from Bridge's 980 Positioning Interface 906, which request the current location from the Positioning Background Framework 940, which will retrieve and return the current location from the OS Core Location Services 950. If the application logic determines that the current location value needs to be recorded with MCHS services 908. Positioning Background Framework 940 makes a token transaction request 912 for an authorization token from Bridge's 980 Token Interface 914. Token Interface 914 retrieves a valid token from token logic application 916 and returns the token to Positioning Background Framework 940 through Token Interface 914. Positioning Background Framework 940 uses the valid token to make Position Update 918 to the external MCHS Position Service 908. MCHS Position Service is also known as spatial data service 310.

At the time of hosting, the real world is synchronized with the digital world to derive the digital coordinates of the anchor.

In an example embodiment, an anchor manager app can be used to host, test, manage, replace, and delete anchors.

In the example embodiment, the hosting process involves two steps. The first step is capturing the spatial features of a given location and creating an anchor in the GCA backend. The second step is to establish the transforms of the hosted anchor in the DCS, thereby synching the anchor's position to the server common coordinate system.

VPS authoring application 402 aids the users to host the anchors in visually distinct locations and sync the coordinate systems.

In the example embodiment, the main application for the example site contains a spatial operating environment, such as in one example embodiment a Unity library, that contains the logic for relocalizing the right anchors. This library communicates with Platform 100 to retrieve the closest anchors to the user, and resolve them as the user scans the location. It also handles fetching the relevant addressable assets from the cloud to populate the world when the anchors are resolved. It also contains the logic for continuous relocalization to minimize error accumulation in a given AR session.

In order to discreetly add augmented reality to a massive real-world space, an accurate 3D digital model, or copy, of the entirety of a site is used. This accurate digital copy may be captured and constructed at the same time that the anchors are authored. Having a physical and digital copy of a location provides the “world map” and basis for aligning virtual augmentations in the real world. Once that foundation is in place, an author hosts the anchor, then users resolve and relocalize their augmentation.

To host, or place an augmentation, an author travels to a particular location within a given site where they want to place an activation. Upon arrival, the author can open an app on an RGB camera-capable device and begin scanning the location from all angles where a spectator may wish to view the experience with the intent of establishing the angles with the best feature points. When the author is satisfied, a cloud anchor is placed and saved in a database on a cloud server along with relevant metadata such as latitude, longitude, and time of day. It is important to retain the knowledge of the time the anchor was created as changing lighting conditions throughout a day can change the viability of certain feature points. If a particular augmentation needs to be viewed 24 hours a day, multiple anchors can be placed with different time considerations.

The metadata may provide an understanding of time, but that anchor currently has no understanding of its position within the virtual world, only which distinct feature points to compare before rendering the augmentation. To remedy this, the real-world scans and associated anchor are aligned with the context of the 3D site model using the same device that scanned the region, such as through a series of manipulation gestures in the app. This alignment generates an actual position of the anchor in the virtual coordinate space. Additionally, the 3D model acts as a map that shows the locations of anchors added throughout the site, so anchors are not lost or forgotten.

Once the location of an anchor is established within a space, the application resolves or accurately determines the position and orientation of a user's camera. A majority of this phase is done by the cloud anchor provider. As there are potentially thousands of existing anchors, the user's device filters potentially viewable anchors within a user's field of view using GPS location and time of day. The camera feed of a user is then referenced to determine whether one or more of the nearby anchors are within the camera's view based on a comparison of feature points established in the previous step. If an anchor cannot be found despite a user attempting to resolve it at the right time and place, a health score within the anchor metadata is updated accordingly. If a health score drops below a certain threshold, the anchor's associated feature points may have been selected poorly, obstructed, or changed. As such, the author or operational staff will be alerted, so they can delete or re-establish the anchor. If the anchor is found, the camera's absolute position and orientation within the coordinate system of the digital world can be determined.

To resolve the anchors, the AR app takes in the GPS location of the user and fetches the nearest anchors based on their GPS position. Once the AR app gets the lists of anchors, the app starts resolving these anchors.

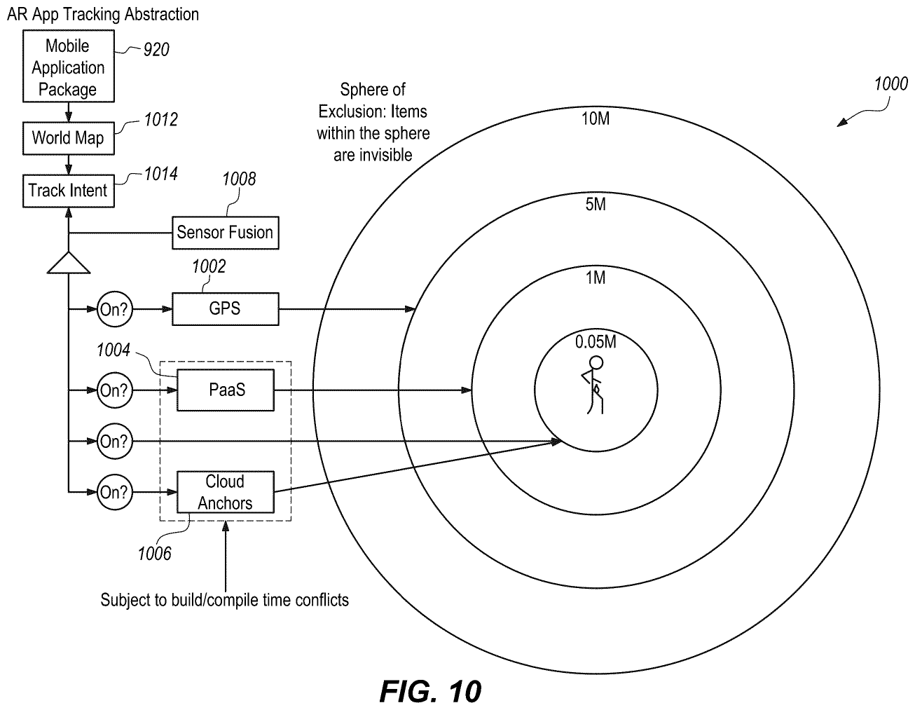

FIG. 10 illustrates AR tracking 1000. AR tracking 1000 relies on multiple levels of abstraction and data fusion. Each layer provides an increase in the level of precision at the expense of latency and processing overhead. In order to provide a satisfactory user experience, VPS 120 stacks the solutions and attempts to solve them in order of complexity, thereby quickly returning a result to the user while becoming increasingly more precise over time. This process is transparent to the user, who receives the highest fidelity experience with the data available in their current environment.

The outermost ring is GPS 1002, which provides a solution in a few seconds with a resolution of several meters. Next, the system attempts to find any accessible Position as a Service (PaaS) solutions 1004, which can take several seconds or minutes but provides a solution within a couple of meters. Finally, the system attempts to resolve any visible cloud anchors 1006. This can also take several minutes but can provide sub-meter resolutions.

The system is able to seamlessly move between the various position solution modalities in a manner that is nearly invisible to the end-user. This is accomplished through sensor fusion 1008 and fluid, animated transitions between modalities. As the solution becomes more precise, the user can enjoy a more accurate representation of the physical space and the placement of digital objects in that space.

This process resolves anchors in parallel so multiple anchors can be looked up simultaneously. In one example embodiment, 40 anchors can be looked up simultaneously.

Because the anchor lookup process is parallel and asynchronous, it is possible to start resolving all the anchors of interest simultaneously. Depending on where the user is viewing and how a particular anchor is hosted, the anchors are progressively resolved.

Resolving additional anchors beyond a certain number comes with performance costs without additional benefits. Therefore, for relocalizing, it is not necessary to resolve all anchors in the vicinity of the viewer. It is only necessary to resolve one. Therefore, in one example embodiment, the user application 160 tops resolving anchors as soon as a set number of anchors, such as 1 or 2, is resolved.

With an established anchor location and camera position, the user is ready for the final step, which is relocalization performed in the Update Client Viewport 530 step in FIGS. 5 and 6. Relocalization is the process by which the application places the camera with respect to the anchor within the virtual world, so that the camera's position and orientation match in both the physical and virtual worlds. Based on the anchor's position, which was created in the first step and the user's position determined in the second step, the camera is placed at a representative viewing angle to provide an accurate perspective on the augmentation. The use of anchors to determine a user's position and orientation within a virtual space allows for a consistent, coherent viewing experience for separate cameras at various angles even as users move throughout a site.

Relocalization involves querying the device for GPS location. In an example embodiment, the GPS location is used to query spatial data service 310 for stored anchor IDs that are nearby. These anchor IDs are shared with the cloud anchor service 410 and then a loop is entered, which includes recording short snippets of video, then sending the video to the cloud anchor service, and receiving anchor found messages with camera relationship metadata when anchors are resolved. The returned anchor camera relationship data and stored location metadata associated with the returned anchor's ID (spatial data service 310) are used to derive the camera location and orientation in the real world.

Connected spaces combined with the physical world provide advantages in a number of applications, such as for design and planning teams, operations, and visitors.

Design and planning teams can collaborate in the physical space that is to be augmented with digital content using the with the assets they have already create for a better representation of the finished experience. They can share work between different teams, so the teams stay synchronized. They can review and approve work in context with stakeholders, so there are no surprises.

Before a new operation goes live, simulations can be run to identify operational issues and confirm readiness. If there are data or devices in the environment, it is possible to monitor them in context for faster and better understanding. If live users are trackable through devices or cameras, meaningful analytics can be visualized to help deliver the best experience. The POI system 180 allows pushing content in context to people's mobile devices relevant to events happening around them.

Connected spaces combined with the physical world also give visitors a better experience and access to richer content, in context, through mobile phones and other devices

Connected spaces combined with users of mobile AR and mixed reality provide advantages in a number of applications, such as for design and planning teams, operations, and visitors.

Design and planning teams can walk the space while it is in progress and see what is coming. They can create narrative journeys, such as tour guides, that can satisfy visitors' interests. They can review digital content in context. They can review and approve work in context with stakeholders.

Before a new operation goes live, the team can get an “Iron Man” or mission control view of the relevant systems and data in the context of the space. The POI system 180 also allows the team to maintain situational awareness for live operations.

Connected spaces combined with users of mobile AR and mixed reality also give visitors access to interactive digital content in context to the physical content personalized to the specific visitors. The POI system 180 in concert with the VPS 120 allows visitors to know where they are and where they want to go with better wayfinding. The POI system 180 in concert with the VPS 120 also allow visitors to keep track of friends and family.

Connected spaces combined with users of VR or remote users on desktop or mobile devices provide advantages in a number of applications, such as for design and planning teams, operations, and visitors, particularly when access to the physical space is prohibitive or impractical.

Design and planning teams can access all the features of mixed reality and regular reality but with superpowers. The lack of constraints from the laws of physics that define purely digital activations unleashes an additional degree of creative freedom and simulation that is not tied to the limitations of a physical environment.

Before a new operation goes live, it is possible to publish and monetize a space to access a remote audience. Connected spaces combined with users of VR or remote users on desktop or mobile devices allow for more space, virtually, for content than the actual physical site offers. Spaces can also be archived so they can live on after the physical space is gone. The team can also manage the live space, see the users, and ensure they are receiving the best experience.

Visitors can access the places and people they want to visit from across the world. POI system 180 enables remote workforces, reduces travel and conference costs, and provides a unified experience across the physical and digital content.

Connected spaces have the advantage of bringing people around the world together. On-site and off-site users can see each other and share a common experience across all consumer devices.

Specifically, on-site physical users can view and interact with a digital layer matched to the physical world through AR. They can have context from positioning and awareness of the content available around them even through traditional interfaces. They have the ability to “replay” their experience, including content they did not engage with, but were proximate to.

Off-site digital users can view and interact with the same digital content interwoven with the digital twin content through desktops, mobile devices, or VR. Off-site digital users can experience superpowers, such as flight. They can access video streams, including 360° video, of the physical site in the correlated digital location to get a more realistic view.

All users can view and interact with other users and content, regardless of platform, to the best of their device and network capabilities.

Numerous applications exist for creating and consuming connected spaces using Platform 100 and the corresponding methods. For example, Platform 100 allows companies to create, update, and manage a virtual online presence their consumers can engage in. Physical spaces can be connected with physical spaces. Platform 100 can connect physical spaces, such as malls, office buildings, entertainment centers, and museums, that are full of digital content and smart devices, allowing management of the digital layer for the physical spaces.

Users can collaborate across the lifecycle of a space. Unlike simple videoconferencing, Platform 100 puts everyone in the same space, regardless of the device, and gives them the ability to work and play together in real time.

Connected spaces can be used for smart buildings and cities. Buildings and public infrastructure are becoming more data rich. Platform 100 offers the ability to make use of that information by empowering the physical and virtual occupants during design, construction, occupation, and operation.

For media and entertainment, connected spaces can create immersive experiences. They can create better films and television programs by building worlds and capturing the story with traditional interfaces. They allow exploring ideas faster with fewer people to ensure the presentation of the best creative result on opening weekend, before the creation of video effects (VFX). Connected spaces make movies agile. Platform 100 provides the ability to see the project early and often when changes are easy and inexpensive. It can provide clarity on costs and outcomes before tough decisions have to be made, and it takes the risks out of the unknown.

Platform 100 allows connecting with the audience in new ways, such as making the brand's content personal, interactive, and engaging by giving the audience a role to play in the next generation of media and taking stories beyond theaters and screens, while benefiting the creation of that media on the way.

Platform 100 can simplify the complexity. As media becomes more digital, the complexity immobilizes everyone and sacrifices creativity and quality as costs rise. Platform 100 overcomes this by ensuring people around the globe, at any time and day, have a real-time, common understanding of the current state of the production and are all referencing the same information.

For live events, conferences, and location-based entertainment venues, the user experience can be customized with dynamic content that designers can refresh and update as needed.

Designing and planning can be done in context. Designers and planners can create narratives, trigger events, and manage entertainment plans across the site. They can explore ideas freely as a team while early in production so they can build and present the best experience on opening day.

Event-management mission control is possible by allowing visualization of connected systems. The APIs of existing systems can be connected for monitoring guest activity and operations in context. The large amount of information can be made actionable.

Connected spaces allow for better connections with the audiences by making the guest experience personal and engaging by using guest analytics. It can provide a digital layer for the guests to engage with on their personal devices and make the event respond to their interests.

Connected spaces allow one or more people to share their experiences with the world. By consolidating digital content in a format that supports next-gen viewing devices, off-site engagement can be taken to new levels, drive more traffic to a physical location, and monetize it.

For retail centers, museums, and public spaces, users want and expect a digital layer. Platform 100 connects occupants of spaces to the opportunities around them in ways that give the operators visibility and enables the spaces to be customized to the occupants. It is possible to create narratives, trigger events, and manage entertainment plans across the site. A digital layer can be created for guests to engage with on their mobile phones and devices to optimize traffic and make the space respond better to their needs.

Retail infrastructure can be managed from the inside. By connecting APIs to existing systems, guest activity and operations can be monitored in context and information can be made actionable.

Retail tenants can be offered a platform to connect with guests in the space. Data is a new type of utility like water and power. By sharing valuable guest analytics with tenants, it will allow tenants to make the guest experience personal and engaging and to help tenants succeed.

As digital content is consolidated in a format that supports next-gen viewing devices, off-site engagement can be driven to new levels and more traffic can be driven to a physical retail location instead of online retail.

Future exhibits can be designed from within for museums and science centers. Platform 100 makes it possible for all teams to work from a shared understanding of the problem and potential solutions and to try out ideas before opening day. When the exhibits are launched, they will engage a younger audience with interactivity though interfaces familiar to that audience.

Visitor experiences at museums or science centers can be better understood and managed. Platform 100 can monitor what is popular and what is not. Then attention can be directed where it is needed, pinch points identified, and flow can be adjusted in real-time to accommodate linger areas.

Existing museum and science center exhibits can be captured and made accessible to remote visitors around the world. Immersive platforms make it possible to preserve exhibits, localize them, and share them with a global audience without the costs of traveling them while controlling access and monetizing them.

Connected spaces can solve the problem of limited space for a museum or science center because immersive content has no walls and can grow to suit content needs. The experience for physical visitors on the site can be as personal as for remote visitors.

Common operational pictures can exist for government spaces and use cases. Systems can be integrated via APIs to create a common interface that is accessible across platforms and teams. Physical assets and sites can be connected through digital twins so everyone is on the same page in real-time.

Platform 100 and connected spaces can provide an environment for master planning and training for government spaces by using digital twins and multi-user collaboration to develop, test, and train assets through scenarios before taking them to the real world. Immersive training for the team is significantly more effective at preparing them for the real world.

Platform 100 and connected spaces can provide situational awareness related to government spaces. Platform 100 makes it possible for all teams to see the same information and collaborate with context. The team becomes far greater than the sum of the individuals when the world is an information-rich environment that is easily accessible and digestible by consumers synchronously or asynchronously.

Platform 100 and connected spaces can provide command and control of government spaces. They allow monitoring real-time events, coordinating assets on the ground, and running simulations in real-time in a simple contextual interface that resembles reality. Information and capabilities can be moved up and down the chain of command with levels of detail that match the context.

Platform 100 can work with smart cities. As urban infrastructure comes online and more connected spaces and buildings are built, the occupants expect an accessible layer of information in context for practical applications.

Platform 100 and connected spaces can be used for master planning for cities and buildings. They allow for a live mission control overview of city events and monitoring data in context via APIs, instead of looking through different systems for pieces of information. Also, future and past events can be visualized in different layers to provide the overall context needed to enable city agents to arrive at the best decision.

Platform 100 and connected spaces can be used for civil and business operations for cities and buildings. For example, they can provide situational awareness for coordinated emergency response efforts, monitor data or devices in the environment in context for faster, better understanding, provide the ability to see teams on-site and what critical information they're streaming, and push content in context to the team's mobile devices relevant to the things happening around them.

Platform 100 and connected spaces can also be used for resident and occupant services for cities and buildings by providing a better experience of what the city has to offer, providing way-finding and navigation, and providing access to richer content in context through mobile phones.

While the invention has been specifically described in connection with certain specific embodiments thereof, it is to be understood that this is by way of illustration and not of limitation. Reasonable variations and modifications are possible within the scope of the foregoing disclosure and drawings without departing from the spirit of the invention.

What is claimed is:

1. A visual positioning system for a connected space comprising:
a three-dimensional model of a physical site;
an imagery of the physical site;
at least one feature point in a plurality of images or video;
at least one anchor in the three-dimensional model of the physical site;
metadata associated with the at least one anchor; and
wherein the visual positioning provides for deploying and consuming augmented reality activations distributed across the physical site using naturally available features.

2. The visual positioning system of claim 1 wherein the three-dimensional model is created using the imagery of the physical site.

3. The visual positioning system of claim 2 wherein the imagery is captured in real time.

4. The visual positioning system of claim 3 where in the three-dimensional model is created using the imagery of the physical site.

5. The visual positioning system of claim 1 wherein the three-dimensional model of the physical site comprises a digitally modeled version of the physical site.

6. The visual positioning system of claim 1 wherein the three-dimensional model of the physical site comprises a captured version of the physical site.

7. The visual positioning system of claim 1 wherein the imagery of the physical site comprises a plurality of images.

8. The visual positioning system of claim 1 wherein the imagery of the physical site comprises a video.

9. The visual positioning system of claim 1 further comprising:
a physical camera at a location in the physical site wherein the imagery of the physical site is provided by the physical camera.

10. A method for visual positioning for a connected space comprising:
providing a physical camera at a location in a physical site;
providing a three-dimensional model of the physical site;
scanning the physical site using the physical camera to locate at least one feature point;
aligning a result of the scanning with an anchor within the three-dimensional model of the site;
associating metadata with the anchor;
determining the location of the physical camera; and
placing a virtual camera with respect to the anchor in the three-dimensional model to allow visualization of the relevant activation at the location of the physical camera.

11. The method of claim 10 further comprising:
providing a location determining component.

12. The method of claim 11 wherein the location determining component is a global positioning system (GPS).

13. The method of claim 11 wherein the location determining component is a compass.

14. The method of claim 11 wherein the location determining component is an inertial measurement unit (IMU).

15. The method of claim 11 wherein determining the location of the physical camera further comprising:
determining one or more coordinates of the location of the camera using the location determining component; and
determining an orientation of the camera using the location determining component.

16. A method for visual positioning for a connected space comprising:
providing a physical camera at a location in a physical site;
determining the location of the camera;
retrieving a digital twin model that includes the location in the physical site;
viewing the physical site using the physical camera;
overlaying the digital twin model over a real-world view provided by the physical camera;
adjusting the digital twin model to align it with a corresponding object in the real- world view; and
defining and placing at least one anchor in an area within the real-world view.

17. The method of claim 16 further comprising:
resolving the anchor to determine an anchor identifier (ID) for the anchor; and
sharing the anchor ID and the location with a spatial data service;

18. The method of claim 17 wherein the resolving the anchor to determine an anchor identifier (ID) for the anchor further comprises:
determining whether one or more previously authored anchors are within a first radius of the anchor;
retrieving one or more previously authored anchors;
initialize a resolving process with a cloud anchor service;
adjust a correlation between a digital coordinate space and one or more real-world coordinates until an orientation of the camera and a position of the camera match the location in the physical site.

19. The method of claim 18 wherein the first radius of the anchor is less than 100 meters.

20. The method of claim 18 wherein the first radius of the anchor is less than or equal to 100 meters and great than or equal to 10 meters.

21. The method of claim 18 wherein the first radius of the anchor is less than or equal to 10 meters.

22. A method for anchor resolution for a connected space to recover the position and orientation of a camera in relation to a physical world comprising:
determining an estimate of a location and orientation of the camera using a location determining application;
querying a data service for at least one anchor within a first radius of the estimate of the location and orientation;
receiving at least one anchor that is within the first radius of the estimate of the location and orientation;
sharing the anchors that are within the first radius of the estimate of the location and orientation with a cloud anchor service;
receiving a position and orientation vector relative to the camera for at least one anchor;
inverting the vector to derive the position and orientation of the camera with respect to the physical world.

23. The method of claim 22 wherein the first radius of the anchor is less than 100 meters.

24. The method of claim 22 wherein the first radius of the anchor is less than or equal to 100 meters and great than or equal to 10 meters.

25. The method of claim 22 wherein the first radius of the anchor is less than or equal to 10 meters.

26. The method of claim 22 wherein the position vector location determining component is a global positioning system (GPS).

27. The method of claim 22 wherein the location determining component is a global positioning system (GPS).

28. The method of claim 22 wherein the location determining component is a compass.

29. The method of claim 22 wherein the location determining component is an inertial measurement unit (IMU).

30. A method for visual positioning for a connected space comprising:
providing a three-dimensional model of a site;
creating a virtual site;
adding anchors to the virtual site; and
spawning a camera in the virtual site.
